(19) United States
(12) Patent Application Publication
(10) Pub. No.: US 2011/0218849 A1
(43) Pub. Date: Sep. 8, 2011

(54) CLOUD PLATFORM FOR MULTIPLE ACCOUNT MANAGEMENT & AUTOMATED TRANSACTION PROCESSING

(76) Inventors: John R. Rutigliano, New York, NY (US); Tomasz Mikluch, Brooklyn, NY (US); John Rutigliano, West Babylon, NY (US); Carol Rutigliano, West Babylon, NY (US); Beata Mikluch, Brooklyn, NY (US); Jerzy Mikluch, Brooklyn, NY (US)

(21) Appl. No.: 13/040,243

(22) Filed: Mar. 3, 2011

Related U.S. Application Data
(60) Provisional application No. 61/310,050, filed on Mar. 3, 2010.

(51) Int. Cl. G06Q 30/00

(52) U.S. Cl. 705/14.25; 705/16; 705/14.53

(57) ABSTRACT

Systems and corresponding methods for managing multiple accounts is provided comprising causing an interface screen to be displayed at a client device that allows a user to link a plurality of accounts to a unified payment device, each of the plurality of accounts having a unique identification number; receiving a request to purchase at least one item from a merchant at a point of sale using the unified payment device; identifying at least one of the plurality of accounts linked to the unique unified payment device to be used to pay for the purchase; processing the request to purchase the at least one item with the at least one of the plurality of accounts identified; and communicating approval for the purchase to the merchant.

The present application claims priority to U.S. Provisional Application No. 61/310,050, filed Mar. 3, 2010, which is hereby incorporated herein by reference.

### BACKGROUND OF THE INVENTION

The present application relates to systems for managing multiple credit and other types of accounts.

Credit and Debit cards have become a cornerstone in our modern way of life. We buy groceries, pay for bills and buy dinner using plastic payment methods more often than with cash. The convenience, simplicity, and speed of using plastic to pay for things have made our lives more efficient. It is estimated, however, that 1 in 7 Americans carries over 10 cards with them at any given time, which can be burdensome to manage. For example, holders of multiple cards must track the various balances, credit limits, and payment due dates associated with each card. If unsuccessful, cardholders will be subject to fees and penalties. Additionally, cardholders are left the extremely burdensome task of reporting a loss of a credit card to each card company in the unfortunate event that cardholders lose their wallet. Accordingly, there is a need for a system or systems to better manage multiple accounts.

### SUMMARY OF THE INVENTION

Systems and methods are provided that allow users to sign onto a portal, provide their credit card/payment details for a plurality of cards to be linked to a single or unified payment card or device, and set rules that dictate the specific type of card to be used for payment using the unified payment card based on conditions specified by the user. For example, a customer may specify that all purchases made at a specific merchant using the unified purchase card, such as Starbucks, get charged to their linked Debit Card while their phone bill from AT&T is charged to their linked Credit Card.

The system may be set up to make the best decision as what card to use for payment, automatically or otherwise, if the user has not set a default or other rule, or otherwise. For example, a user may link a metro card or other prepaid card to the unified payment card or system. Since the metro system only works with a metro card, the system may automatically use the metro card payment option at the point of sale. Users may also be able to refill their metro card or any other prepaid card online with the interface provided thereby allowing the user to use the unified payment card for payment at the point of sale. In this instance, the system provides a sort of common sense “AI” back up system for cards that only work or work best in specific situations as stated above. For all other cases, the user can set a “primary” default card for charges that occur in places where no specific rule has been set. By allowing the system to operate automatically in this respect, the system makes decisions on the fly as which card would be the best to charge.

Using the automated payment system as described herein, the customer only needs to carry and scan the unified payment card at a terminal at the point of purchase, and the system will process the request and charge the appropriate payment option on file. The system may also include tracking features that provide users with a better view of their spending habits. Beneficially, the user no longer has to worry about pulling out the correct card or remembering the right pin since all of the user's payment options are consolidated through the unified payment card. If the user loses the unified payment card, the user only has to make a single phone call to freeze its operation. The system preferably does all of the processing in the backend, which limits theft of the linked card information. All of the user's regular credit cards will continue to be functional and the user will benefit from any existing rewards programs. The system can also be used as a means to pay for transit, small-unmanned kiosk purchases (newspapers, vending machines etc.), as well as any other situation where funds are being transferred from one party to another.

In at least one embodiment, a system for managing multiple accounts is provided comprising at least one computing device coupled to client device over a computer network, the at least one computing device having software associated therewith that when executed by the at least one computing device causes the at least one computing device to perform a method comprising: causing an interface screen to be displayed at a client device that allows a user to link a plurality of accounts to a unified payment device, each of the plurality of accounts having a unique identification number; receiving a request to purchase at least one item from a merchant at a point of sale using the unified payment device; identifying at least one of the plurality of accounts linked to the unique unified payment device to be used to pay for the purchase; processing the request to purchase the at least one item with the at least one of the plurality of accounts identified; and communicating approval for the purchase to the merchant.

In at least one embodiment, the plurality of accounts comprise at least two types of accounts selected from a group of accounts consisting of a credit card account, a bank account, a debit account, a utility account, a loan account, a cable account, a metro account, and a retailer awards account.

In at least one embodiment, the method further comprising retrieving from an account provider associated with each of the plurality accounts at least one of an account balance, an account limit, and a payment due date.

In at least one embodiment, the method further comprising retrieving information from an account provider associated with each of the plurality accounts at least one of an account balance, an account limit, and a payment due date and causing an interface screen to be displayed at the client device the information retrieved.

In at least one embodiment, the method further comprising tracking purchases made with the unified payment device from at least one merchant and communicating an offer for at least one item to the user of the unified payment device based on the purchases tracked.

In at least one embodiment, the offer comprises a coupon for the at least one item from a competing merchant.

In at least one embodiment, the unified payment device comprises at least one of: a magnetic strip card, an RFID card, a card with a barcode.

In at least one embodiment, the point of sale terminal comprises at least one of a magnetic strip card reader, an RFID Tag reader, and bar code scanner.

In at least one embodiment, the method comprising storing a purchase profile associated with the user, the profile comprising at least one rule that dictates how payment is to be made using the unified payment device, the method comprising identifying the at least one of the plurality of accounts based on the at least one rule in the purchase profile.

In at least one embodiment, the at least one rule is merchant specific and wherein identifying the at least one account comprises identifying the merchant and processing the request to purchase the at least one item using a first account dictated by the at least one rule.

In at least one embodiment, identifying the at least one account further comprises using processing the request to purchase the at least one item using a second account dictated by the at least one rule.

In at least one embodiment, the first account is one of a credit account and a debit account, and the second account is a merchant reward account.

In at least one embodiment, the request is to purchase a plurality of products, the method further comprising splitting the purchase between the first and the second accounts.

In at least one embodiment, the system splits the purchase between the first and second accounts based on a category associated with a first and a second of the plurality of products.

In at least one embodiment, the system splits the purchase between the first and the second accounts based on a limit associated with at least one of the first and the second accounts.

### BRIEF DESCRIPTION OF THE FIGURES

FIG. 1 depicts a system for use in managing multiple accounts according to at least one embodiment of the systems disclosed herein;

FIG. 2 depicts a process flow according to at least one of the methods disclosed herein;

FIG. 3-4 depicts interface screens for use in managing multiple accounts according to at least one of the embodiment of the systems disclosed herein

### DETAILED DESCRIPTION OF THE INVENTION

The present application generally provides systems and corresponding methods for managing multiple accounts, credit, debit, or otherwise. Although the particular embodiments disclosed herein may reference particular types of accounts, such as credit or debit, it is understood that the methods disclosed herein apply to other types of accounts, such as rewards, point rewards, loans, utility, cable, etc.

There are many reasons to have multiple cards and accounts, such as beneficial rewards and point rewards systems, varied interest rates, various continuity programs, etc., but the more cards we have, the bigger of a hassle it is to manage them. The present application addresses this problem by providing a system that allows users to link some or all their cards and/or other accounts into unified payment device/system, be it a traditional card, RFID card, or any other device that may be used to identify the particular purchaser using the device.

Traditionally, the mode of payment for an item is decided at the point of sale, i.e., whether payment will be made by cash, credit card, or debit card. The system of the present application allows users to carry only one card or payment device for all their payment needs. That is, the present system allows users, instead of carrying a bank's debit card, a credit card, a customer loyalty card, a metro pass, etc., to link their accounts into a single card or payment device, have all the payments auto processed using the payment device, and preferably tracked via a website. The system further allows users to consolidate their accounts and therefore manage their finances more efficiently and effectively. When fully implemented, the system may provide a “one stop financial spot” where users can manage their finances across the board, including bank accounts, credit cards accounts, any number of utility companies and other merchants accounts, etc.

The system may also be used by stores or merchants to provide continuity programs built right into the payment device without the need for an additional card. For example, a coffee shop may virtually track a customer's purchases using the payment device and can offer the customer automatically every 10^{th} cup of coffee for free based on their past purchase history. Coupons and special offers may similarly be communicated to the customer based on their past purchasing habits or based on use demographic data. For example, coupons from similar or competing products may be offered to the users of the device based on their previous purchases. Similarly, certain offers may be offered to users based on their gender and age. Traditionally, credit cards are only used as a method to transfer funds between the customer and the merchant, but the system of the present invention allows this simple transaction to build relationships between the device holder and the merchant without the need for additional cards.

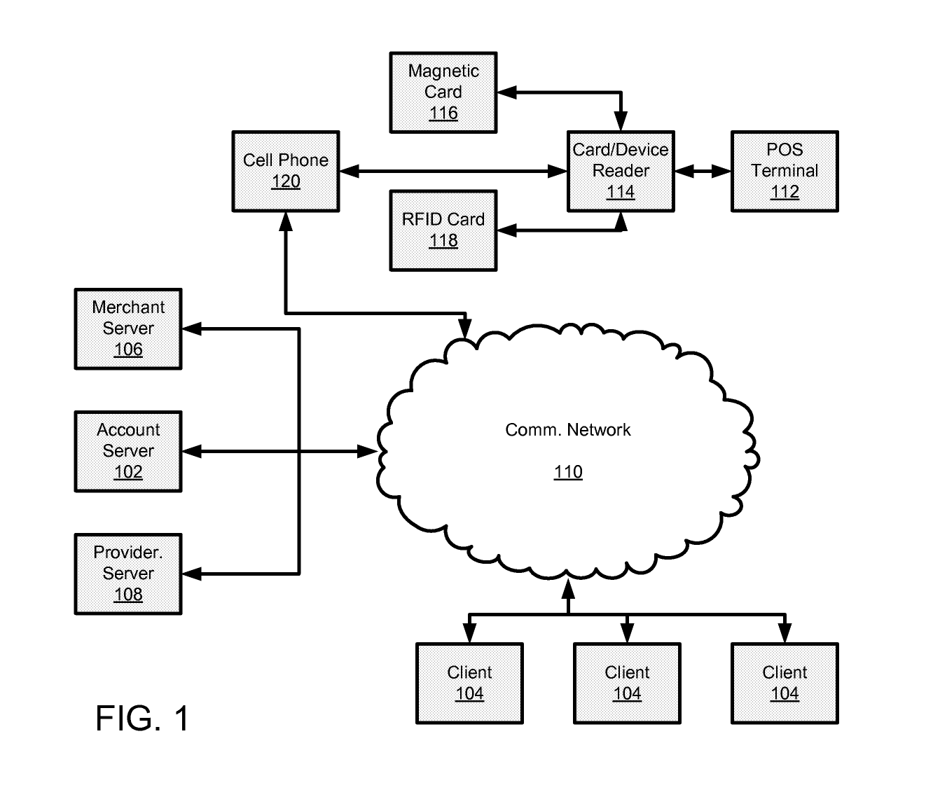

The system may be implemented with a mix of hardware and software. However, the system preferably leverages the existing payment infrastructure, i.e., credit card payment systems, be it a magnetic strip card reader, an RFID Tag reader, bar code scanner, or other device for reading an authenticated item. Referring to FIG. 1, a system 100 according to at least one embodiment includes at least one computing device that provides some or all of functionality disclosed herein. That is, the functionality disclosed herein may be implemented in a stand alone device and/or on multiple linked devices. In at least one embodiment, the at least one computing device includes at least one server computer 108 coupled over a communication network 110 to at least one client device 104. Multiple sets of server computers may be used to provide the relevant functionality disclosed herein separately or in conjunction with each other. For example, one set of servers may be provided by each of the parties involved in the processes discussed herein. For instance, at least one or a set of server computers 108 may be used by the service provider that provides the multiple-account linking and management functionality discussed herein. Another one or a set of server computer 102 may be used by each of the providers of the individual linked accounts and another one or a set of server computers 106 may be used by each of the merchants that accept payment via the unified payment device. The merchant servers 106 may further be coupled to a point of sale terminal 112 or the point of sale terminal 112 may be a stand alone device that includes a device reader, such as a magnetic card 116, RFID card 118, or a bar code reader(s). The unified payment device may be any uniquely identifiable item, including a cell phone 120. The device reader 114 is therefore able to receive a unique ID associated with the unified payment device.

The devices in the system are preferably configured or otherwise capable of transmitting and/or receiving communications to and/or from each other. This may be accomplished with a communication element, such as a modem, an Ethernet interface, a transmitter/receiver, etc., that enables communication with a similarly equipped device, wirelessly, wired, or a combination thereof.

The computing device, e.g., the server, client, etc., generally includes at least one processor, and a memory, such as ROM, RAM, FLASH, etc., or any computer readable medium, such as a hard drive, a flash-drive, an optical or magnetic disk, etc. The memory or computer readable medium preferably includes software stored thereon that when executed performs one or more steps of the methods disclosed herein, including communicating data back and forth between devices, storing data, displaying interface screens, etc. The computing device may also be associated with or have access to one or more databases for retrieving and storing the various types of data discussed herein, including identity verification data, such as an ID and password, user profile data, such as the user name, identification number, address, payment preferences, unified payment device data, credit, debit or any other account data, such as account balances, payment dates, account maximums, points, rewards, etc.

The client device 114 may be, without limitation, a mobile or smart phone, PDA, pocket PC, personal computer, as well as any special or general purpose device. As such, the device 114 preferably includes a processor, a memory, a display, such as a CRT or an LCD monitor, for displaying information and/or graphics associated with the services provided by the system, and at least one input device for users to enter commands and/or information relevant to the system services, such as a mouse, a touch-sensitive pad, a pointer, a stylus, a trackball, a button, e.g., alphanumeric, a scroll wheel, a touch-sensitive monitor, etc., or a combination thereof. With the general purpose type devices 114, such as the PC or PDA, users may access the services provided by the system 100 with a browser or any other generic application, or with special purpose software designed specifically for accessing and providing the services disclosed herein.

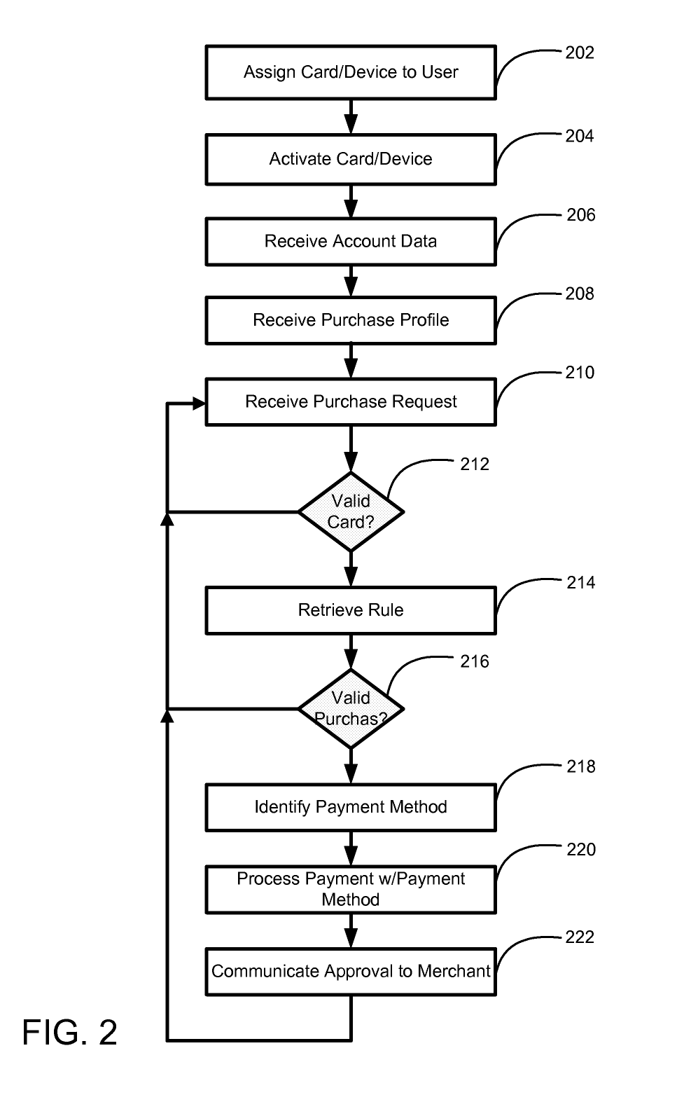

Referring to FIG. 2, in at least one embodiment, a method is provided that begins with providing a user or device holder with the unified payment device 202. The user may acquire the unified payment device, e.g., a card, through any numbers of options, such as via mail, store pickup, etc. The unified payment device may be a magnetic strip card, a card with a bar code, an RFID card, an RFID key tag/fob, an RFID sticker, or any kind of authentication device, or a combination thereof. For example, a card may be provided with a plurality of authentication mechanisms so that the card is compatible with more than one type of receiver at the point of sale. For instance, a unified payment card may be provided that includes a magnetic strip and a bar code. In operation, each identification mechanism may be read separately as needed. For example, the bar code on the card can be scanned so that the merchant's reward or discount program may be updated, and the magnetic strip can be read for actual payment. RFID badges may be placed or built in specific items, such as cell phones. If a user switches phones, all the user needs to do is activate the new chip associated with the cell phone and continue using the system.

The user may then activate the unified payment device 204 via a website or some other means, such as by telephone. In not already present, the user may be prompted to provide user data, such as login ID, password, name, address, telephone, etc. The user may then be prompted to enter particular accounts to be linked to the unified payment device. In this instance, the user will input data regarding his or her credit card account, bank account, debit card account, or any other type of retailer credit or rewards card. The system receives account data for these accounts, such as account numbers, provider names, etc. at 206. The user may also provide other data relevant to managing the individual accounts, such as account balances, limits, payment due dates, etc. Some or all of this data may be downloaded directly from the account provider. For example, card balances and limits may be downloaded directly from the credit card provider based on the account number or other information provided by the user. If a user ID, password, or pin number is necessary to accesses account data from the account provider, the system may prompt the user for such data and store that data for initial access and for periodic updates.

Once these items are input into the system, the user is thereafter able to specify or input one or more purchase profiles. In this instance, the system receives the purchase profile data at 208. The purchase profile generally includes at least one rule that dictates how payment will be made when the unified payment card is used for purchases. The payment rule may be merchant or product specific. That is, a rule may apply to a specific merchant. For example, a purchase profile may include a rule that specifies that all purchases made at Starbucks or for coffee be paid automatically using a specific debit card. In this instance, upon swiping the unified payment card at Starbucks, the user's payment rule will be triggered automatically and the specified payment option will be used for the purchase. The rules may be set for broader categories of products. For example, another rule may be created for the “food” category, which dictates that these types of purchases be made using a specific credit card. The system or the user may keep record of which merchants are considered to be in the food business, and any time the user makes a purchase using the unified purchase card at a food category locale, the specified credit card will be used for payment.

The user may also create payment rules on other criteria as well, such as the amount of the transaction, a default payment option in case one payment option is rejected or if there is no applicable rule, rewards programs, etc. For example, a second account may be specified to be used when it is determined that the then current purchase would exceed the balance or limit of the primary account. Similarly, purchases may be made using specific credit accounts based on the best reward or cash back at the time of purchase. Sub-accounts may also be created that would allow an administrator to specify rules that would block certain purchase. For example, a parent may create a sub account for a child that is away at college. The parent may create a rule that prevents the child from paying for goods from certain merchants or for certain types of goods using the unified payment card. Users are preferably able to continuously add profiles and rules by logging into their account at any time and editing their payment options.

After the account is set up the user may use the unified payment device to purchase goods and services like any other card. In this instance, the system 100 receives a purchase request at 210 from the point of sale terminal 112 or from the merchant server 106. The purchase request may include data associated with the unified payment device being used, such as an ID, the purchase amount, the merchant ID or name, the type of goods sold by the merchant or the type of individual goods or services being purchased, etc. The system thereafter processes the purchase.

The system may process the purchase a variety of ways. For instance, the system may first authenticate the unified payment card used by determining at 212 that the specific unified payment card number or other ID associated with the request is valid. This may be accomplished by comparing some or all of the purchase data with data in a database associated with the service provider servers 108. For valid cards, the system then retrieves from the service provider server 108 at least one purchase rule associated with the particular unified purchase device being used at 214. If there is a rule that blocks certain purchases, the system may determine if the particular purchase is a valid at 216 based on the type of or the individual goods and services being purchased, the purchase amount, etc.

For valid requests, the system may thereafter identify a payment method to be used to complete the purchase based on the purchase profile at 218 and process the purchase request with the identified payment method at 220. This too may be accomplished in a variety of ways. For instance, the system may communicate a purchase authorization request to the account server 102 associated with the identified payment method. For example, assuming that the purchase rule dictates that a particular debit card is to be used for the purchase, the system will communicate the request to the bank associated with the particular debit account. The system may similarly submit another request to a second payment method when the primary method fails. The system is preferably able to split the purchase amount between two or more the linked accounts. In this instance, the system communicates the split requests to each of the particular account servers 102 associated with the identified payment methods or accounts. Once authorized, the authorization and the particular identified accounts are communicated to the merchant server 102 or to the point of sale terminal 112, as the case may be, at 222 to complete the transaction. Alternatively or additionally, the server may communicate the identified payment option to the merchant server 102 and/or the point of sale terminal 112. Processing may then be carried out by the merchant based on the identified accounts to be used to complete the purchase.

As noted above, the purchases can be split between linked accounts. This too may be based on rules in the purchase profile. For example, the purchase may be split based on the particular types of goods being purchased. For instance, pharmaceutical goods may be paid using the card issued by a flexible spending account provider and non-qualifying goods may be paid with another account. The purchase may also be split so as not to exceed any limits on an identified account and may also be split to maximize rewards programs.

The user is preferably provided with an interface for interacting with the system. For example, a website may be accessed by the user to keep track of all purchases made using their unified card payment system, as well as have the ability view online receipts, and even access customer support in some cases. Utility companies and other payees may also be added to the website, which will allow the customer to pay for all their bills in one area. Bill due dates and update notifications would preferably be pushed to the customer, e.g., via email, text messages, etc., which will allow them to have a more holistic approach to their finances.

The interface may also allow the user to view all their purchases using the unified payment device and see which payment option was used to pay for each transaction. Users are preferably able to edit the payment details so that all future purchases fall into a new payment option. For example, assuming the user paid for lunch at a new restaurant, and the default “food category” payment option was used based on your initial preferences. If the user now wants to make sure that for all future purchases you use your debit card for this particular merchant, the user would simply edit the transaction and add the merchant to your profile. Now every time the user goes back to that restaurant, instead of pulling funds from the credit card, funds will instead be drawn from the debit card.

The system may also allow merchants to build a strong relationship with their customers, while at the same time offering them the conveniences of quicker payment options. Merchants may therefore also be provided with an interface to the system. A merchant, for example, may be able to set up their profile on a website and fill out basic questions regarding their business and its purpose. Once the merchant fills out their profile and if necessary acquires a device reader, the merchant will be able to start using it for their store operations. The merchant may also be able to view their daily income streams, which allows them to use this information more effectively for marketing campaigns as well as other initiatives. The merchant will not only be getting money from their customers, but also information that is invaluable about their customer's purchasing habits. Merchants may be able to offer discounts to repeat customers, and have these discounts applied automatically based on the customer's region, how long they've been a customer (based on when they made their first purchase using the system), how frequently they visit the establishment and any number of other situational scenarios.

Merchants may also be given access to potential new customers based on non-customer spending habits and/or demographics. For example, the system may identify a list of relevant unified card users that the merchant may want to target with offers or other advertising. Relevance may be determined based on spending habits of the non-customers. For example, non-customers may be shopping with competing merchants within the proximity of the merchant's locale. Based on this information, the merchant may choose to offer free merchandise to entice non-customers into their store. Demographics, such as age and gender, may also play a role in determining relevance. For example, relevant non-customers for a merchant may be individuals that meet the merchant's target customers, e.g., males under age 30, etc. The merchant view may offer stronger tools and more features compared to the customer view, which may justify a small price premium over using other payment options. Alternatively or additionally, the service may be funded by advertising.

The system may also be a central payment clearinghouse for multiple credit and other cards. In the current model, there are 4 major credit card carriers: Amex, Master Card, Visa and Discover. Without a central payment clearinghouse the customer is limited to only using one system and sticking with it for convenience. The present system beneficially allows the user to use multiple cards while only having to carry a single unified payment card or device. The system stores all of the user's credit card information and uses the information for future purchase use based on one or more payment profiles or rules created by the user that dictate which card is to be used in which situation.

For example, the user may create a rule that states that coffee purchases are to be charged to the user's debit card. Upon making a purchase at a coffee store and paying with the unified payment card, the system will identify the purchase as being in the “coffee” category, and will proceed to use the information stored previously by the customer to charge and get payment.

Rules are applied and payment mode is identified by the backend processing performed in the service provider servers. In one embodiment, a merchant is assigned a unique ID as well as a category (or set of categories). When a purchase is made using the unified payment card, the amount to be charged, the client's authentication information as well as this unique ID is sent to service provider servers. The servers process the request with the given the information as noted above. The customer is then able to view this transaction as well as the receipt for the transaction when they log onto the website.

The payment rule decision may be based on a merchant profile or category level. Category Level is generally defined as a category for a purchase. For example, a merchant may be considered to be in the “groceries” category while another merchant would be in the “coffee house” category. The user can decide which card to use at which retailer based on this distinction. The user can then log onto the site and edit the default payment options for any future purchases at the store. The user may also set up which card will be charged based not only by category but also by actual merchant. Since people use their cards at the same stores on a daily or weekly basis, being able to customize the payment option in this respect will be beneficial. The user may also set up a default payment option when the user buys something at a new merchant and there isn't a predefined payment rule set in place). In additional, rules may be set up for an alternate payment in the event that an overdraft occur, to allow purchases to be split between different cards, and to create a hierarchy of payment option decisions where payment options are listed and ranked in order of being used as backup or alternate payment options.

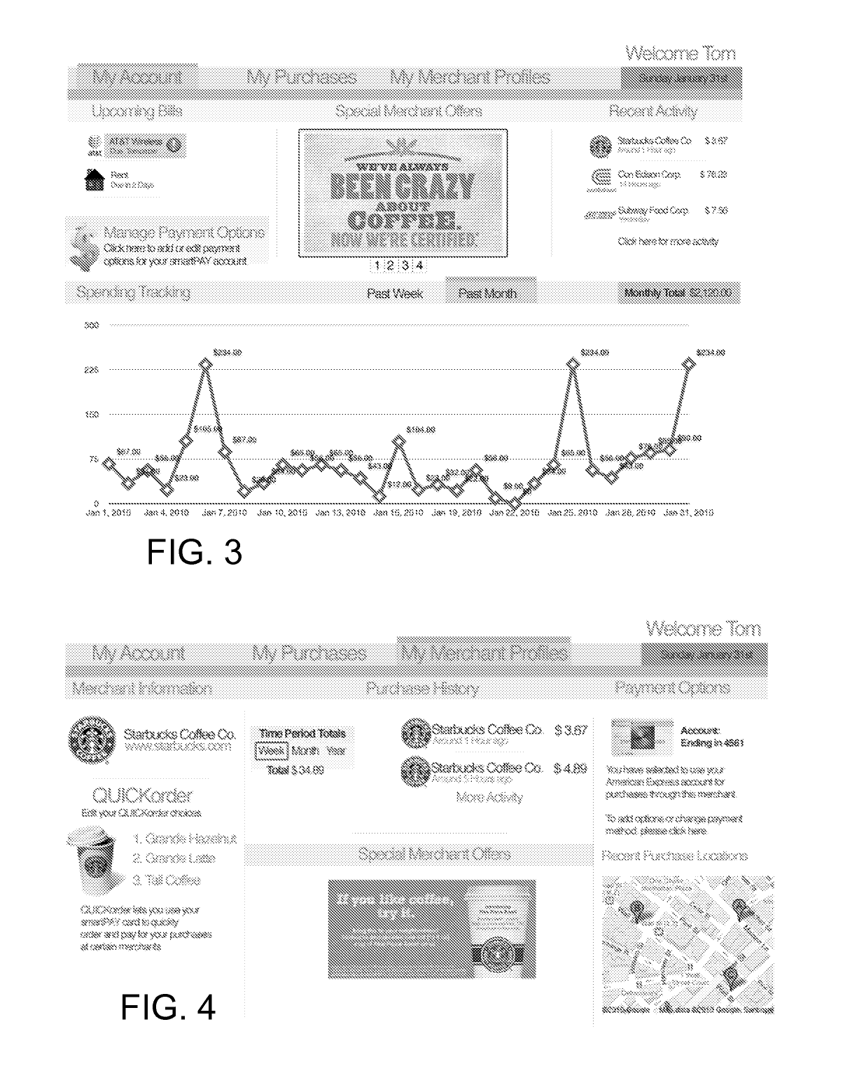

As noted herein, the user interface provides a convenient place to manage multiple accounts. For example, the system may communicate to the user a page, such as the interface screen shown in FIG. 3, that includes outstanding balances of all these accounts in one place and preferably allows the user to pay all of the linked accounts online. Other bills, such as utilities, phone internet, cable/satellite etc., may also be linked, which further consolidates the users monthly obligations. A calendar or other system may be included that allows the user to view the due dates and the amounts due. This information may be retrieved directly from the account provider so that all of the correct balances and due dates are shown to the user in one place. This allows the system to provide accurate automated reminders of due dates. The system may also provide the users with historic purchasing information. That is, users may be able to track their finances and track all of their spending based on a merchant/category or even a “global” view of all purchases.

As noted herein, users may be able to pay their bills online directly from the interface. That is, payment may be made from savings, checking, or other accounts linked in the system. Funds may also be transferred to users from other users.

The website may be used for targeted marketing. That is, when a user logs onto the site, their anonymous purchase history may be used provide marketers with a more focused channel. Charities may also create profiles and similarly target potential donors. Funds raised by charities may be bundled and transferred directly to the charity. Individual donors may also create pools of donations by sending a public link out to other users and non-users of the system. Non-user donors may be asked to create accounts and link an account from which the donation will be drawn.

Referring to FIG. 3, a homepage for a user according to at least one embodiment is shown. Users are able therewith to navigate all the site features from the home page. The upcoming bills section outlines bills that need to be paid in the coming days. The special merchant offers section is where paid advertising may be shown to the user based on their anonymous purchase history. The Recent Activity section outlines all the recent transactions that user has established. Clicking on any transaction item will preferably bring you to the merchant profile. The Spending Tracking zone allows you to track all spending across all merchants and all cards over a specified time period.

Every part of the site may be fully customizable to the user's preference. Each “region” is a so-called “widget” that serves a certain use. These widgets can be moved from region to region or deleted at will by the customer. Companies may offer specialized widgets that we will provide the customer to make their experience more interactive. The purpose of this is to present the customer the information they find most valuable. For example, a business owner may want to track all their spending differently compared to a college student, and graphs sometimes scare people, so they may have the option of taking them off. A recommended default view may be provided for those people who wouldn't care either way.

Referring to FIG. 4, a typical merchant profile view according to at least one embodiment is shown. For this view, a customer would have set up a Starbucks profile that allows them to track their spending and also edit their payment options for the merchant. Under the Merchant Information section, the company information/website and other contact information may be shown. The QUICK order section allows a user to specify their most frequently purchased drinks. For example, instead of the customer ordering verbally what they want with a cashier, they can swipe their card at a Touch screen self serve kiosk in the store and pick which drink they want. The QUICK order may be limited to 3 or 5 drinks so the process of ordering is fast. The order then would pop up on a screen for the barista to view and make, and for the customer to pick up. The customer is able to order and pay for their drink without any human interaction. This will make the morning coffee run much more efficient and much faster. The unified purchase card can be used as a token to customize the customer experience online as well as in-store; in essence, it is capable of bridging the gap between online interaction and reality. This is just one example of how the card may be used for much more than just for payment. Loyalty programs can work the same way, and everything is managed from a single source.

Under the purchase history section of the screenshot, the customer views all their recent purchases and is able to track their spending at the merchant. Under special merchant offers, paid ads from the merchant may be shown. The payment options section allows the user to select which card to use when buying something at the establishment. This view is completely customizable by the user so they can see information relevant to their interests about the merchant. For example, you can add a Starbucks Locate wizard, which lets you find the store locations in your vicinity. The merchant can add additional features to make this experience more engaging with surveys or any other form of involvement.

While the foregoing invention has been described in some detail for purposes of clarity and understanding, it will be appreciated by one skilled in the art, from a reading of the disclosure, that various changes in form and detail can be made without departing from the true scope of the invention in the appended claims.

What is claimed is:

1. A system for managing multiple accounts comprising at least one computing device coupled to client device over a computer network, the at least one computing device having software associated therewith that when executed by the at least one computing device causes the at least one computing device to perform a method comprising:
causing an interface screen to be displayed at a client device that allows a user to link a plurality of accounts to a unified payment device, each of the plurality of accounts having a unique identification number;
receiving a request to purchase at least one item from a merchant at a point of sale using the unified payment device;
identifying at least one of the plurality of accounts linked to the unique unified payment device to be used to pay for the purchase;
processing the request to purchase the at least one item with the at least one of the plurality of accounts identified; and
communicating approval for the purchase to the merchant.

2. The system of claim 1, wherein the plurality of accounts comprise at least two types of accounts selected from a group of accounts consisting of a credit card account, a bank account, a debit account, a utility account, a loan account, a cable account, a metro account, and a retailer awards account.

3. The system of claim 2, the method further comprising retrieving from an account provider associated with each of the plurality accounts at least one of an account balance, an account limit, and a payment due date.

4. The system of claim 1, the method further comprising retrieving information from an account provider associated with each of the plurality accounts at least one of an account balance, an account limit, and a payment due date and causing an interface screen to be displayed at the client device the information retrieved.

5. The system of claim 1, the method further comprising tracking purchases made with the unified payment device from at least one merchant and communicating an offer for at least one item to the user of the unified payment device based on the purchases tracked.

6. The system of claim 5, wherein the offer comprises a coupon for the at least one item from a competing merchant.

7. The system of claim 1, wherein the unified payment device comprises at least one of: a magnetic strip card, an RFID card, a card with a barcode.

8. The system of claim 1, wherein the point of sale terminal comprises at least one of a magnetic strip card reader, an RFID Tag reader, and bar code scanner.

9. The system of claim 1, the method comprising storing a purchase profile associated with the user, the profile comprising at least one rule that dictates how payment is to be made using the unified payment device, the method comprising identifying the at least one of the plurality of accounts based on the at least one rule in the purchase profile.

10. The system of claim 9, wherein the at least one rule is merchant specific and wherein identifying the at least one account comprises identifying the merchant and processing the request to purchase the at least one item using a first account dictated by the at least one rule.

11. The system of claim 10, wherein identifying the at least one account further comprises using processing the request to purchase the at least one item using a second account dictated by the at least one rule.

12. The system of claim 11, wherein the first account is one of a credit account and a debit account, and the second account is a merchant reward account.

13. The system of claim 11, wherein the request is to purchase a plurality of products, the method further comprising splitting the purchase between the first and the second accounts.

14. The system of claim 13, wherein the system splits the purchase between the first and second accounts based on a category associated with a first and a second of the plurality of products.

15. The system of claim 13, wherein the system splits the purchase between the first and the second accounts based on a limit associated with at least one of the first and the second accounts.

16. A system for managing multiple accounts comprising at least one computing device coupled to client device over a computer network, the at least one computing device having software associated therewith that when executed by the at least one computing device causes the at least one computing device to perform a method comprising:
causing an interface screen to be displayed at a client device that allows a user to link a plurality of accounts to a unified payment device, each of the plurality of accounts having a unique identification number;
storing a purchase profile associated with the user, the profile comprising at least one rule that dictates how payment is to be made using the unified payment device;
receiving a request to purchase at least one item from a merchant at a point of sale using the unified payment device;
identifying a first and a second of the plurality of accounts linked to the unique unified payment device to be used to pay for the purchase based on the at least one rule;
splitting the purchase between the first and the second account;
processing the request to purchase the at least one item with the first and the second accounts identified; and
communicating approval for the purchase to the merchant.

17. The system of claim 16, wherein the system splits the purchase between the first and second accounts based on a category associated with a first and a second of a plurality of products.

18. The system of claim 16, wherein the system splits the purchase between the first and the second accounts based on a limit associated with at least one of the first and the second accounts.
